(19) United States
(12) Patent Application Publication
(10) Pub. No.: US 2025/0201036 A1
(43) Pub. Date: Jun. 19, 2025

(54) A METHOD AND SYSTEM FOR GENERATING A VEHICLE MILEAGE

(71) Applicant: APPY RISK TECHNOLOGIES LIMITED, Crewe (GB)

(72) Inventors: Robert MADDOCK, West Yorkshire (GB); Andrew WRIGHT, West Yorkshire (GB)

(73) Assignee: APPY RISK TECHNOLOGIES LIMITED, Crewe (GB)

(21) Appl. No.: 18/868,310

(22) PCT Filed: May 19, 2023
(86) PCT No.: PCT/GB2023/051325

§ 371 Date: Nov. 22, 2024

(30) Foreign Application Priority Data
May 20, 2022 (GB) 2207411.6

(51) Int. Cl. G07C 5/02

(52) U.S. Cl. CPC G07C 5/02

(57) ABSTRACT

A computer implemented method for generating a vehicle mileage includes controlling at least one accelerometer on-board the vehicle to capture and characterise the acceleration readings in at least one of 3 orthogonal axes while the vehicle is in motion; calculating, based on the variational characteristics (such as max, min, mean, variance) of these readings captured, an axis independent acceleration value; and generating a set of axis independent acceleration values correlated with different observed speeds of the vehicle.

### TECHNICAL FIELD OF THE INVENTION

The present invention relates generally to the field of vehicle telematics and more specifically to a method and system for generating a vehicle mileage or distance travelled which is independent of an OEM vehicle control system and also not reliant on a positioning system such as GPS.

### BACKGROUND TO THE INVENTION

Mobile telematics, through the provision of an in-vehicle mobile telematics device which is separate to the OEM vehicle control system and telematics system, allows the collection of information that third parties such as vehicle insurers, rental companies and service, maintenance and repair (SMR) organisations find valuable, but which is not usually collected by the OEM vehicle control system and telematics system.

Mobile telematics allows collection of additional information regarding the vehicle and the manner in which the vehicle is driven, which in turn allows a mobile telematics system to calculate parameters such as:
Vehicle speed relative to expected travel speed;
Acceleration;
Braking
Harsh cornering;
Distance travelled;
Driver aggression;
Road type and/or quality; and
Road infrastructure such as roundabouts or ramps.

Over the years, there has bene in increase in usage-based insurance (UBI) and mileage based charges, both of which can be based, at least partially, on the distance travelled by a vehicle.

Again, although mileage information can be collected from the OEM vehicle control system and telematics system and/or location systems such as GPS, it would be advantageous if an in-vehicle mobile telematics device could be used to collect information allowing a vehicle mileage or distance travelled to be determined.

One problem in using an in-vehicle mobile telematics device to determine vehicle mileage or distance travelled is the fact that such a device is usually independent of the OEM vehicle control system and telematics system. It therefore cannot rely on information which is available to the OEM vehicle control system and telematics system.

Known in-vehicle mobile telematics devices may include a location device allowing the in-vehicle mobile telematics device to determine its location at any point in time and changes over time, to allow a determination of mileage travelled. However, if the location device is not functioning correctly or the signal is lost for any reason, the mileage cannot be determined. It would also be helpful if the in-vehicle mobile telematics device could be used to determine vehicle mileage or distance travelled independently of a location system such as GPS.

Prior art attempts to estimate mileage from an in-vehicle mobile telematics device have focused on using the journey duration to predict distance travelled. The accuracy of such a simple estimate is adversely affected by the vehicle being stuck in traffic, sitting idle waiting for traffic signals, or waiting for the car to defrost and the like as well as variations in speed of travel over the time taken. The ‘vehicle stationary time’ varies from journey to journey and are affected by other variables such as by time of day for example.

It would therefore be a significant development in this field if a method and system for generating a vehicle mileage which is accurate and reliable whilst also being independent of the OEM vehicle control system and telematics system, and location systems such as GPS, were provided.

### SUMMARY OF THE INVENTION

According to a broad aspect, there is provided a computer implemented method for generating a vehicle mileage comprising the steps of:
a. Controlling at least one accelerometer on-board the vehicle to capture acceleration readings in one or more axes while the vehicle is in motion;
b. Calculating, based on the acceleration readings captured, an axis independent acceleration value; and
c. Generating a set of axis independent acceleration values correlated with different observed speeds of the vehicle.

The acceleration readings captured are used to capture the variation in acceleration, compared to different observed speeds of the vehicle. This variation can then preferably be correlated with speed of the vehicle to ascertain an estimate of vehicle speed (using the acceleration readings captured) and to estimate a distance travelled from vehicle speed and time travelled at vehicle speed.

Preferably, one or more characteristics of the acceleration readings captured will be used. Preferably, one or more characteristics which vary over time or during a journey will be used. The one or more characteristics of the acceleration readings captured may be or include a statistical characteristic for example maximum acceleration, minimum acceleration, mean acceleration, standard deviation of acceleration readings or the variance of acceleration readings.

The acceleration readings may be captured in one or more axes. The preferred axes are normally relative to the at least one accelerometer capturing the readings. The preferred axes are an X-axis, a Y-axis and a Z-axis. These axes do not have to correspond to the axes of the vehicle.

The one or more characteristics of the acceleration readings captured may be used for one or more of the axes in the calculation of the axis independent acceleration values. The axis independent acceleration value(s) is therefore preferably based on one or more characteristics of the acceleration readings captured in relation to one or more of the axes, but be axis independent, so as to measure a variation of the acceleration and correlating that to speed and therefore distance.

The acceleration readings in at least one axis may be characterised using a statistical analysis method to determine or develop a distribution of acceleration readings over time. At least one and preferably a number of axis independent acceleration values can then be calculated based on the characteristics of the acceleration readings as they vary over time.

According to a first aspect there is provided a computer implemented method for generating a vehicle mileage comprising the steps of:
a. Controlling at least one accelerometer on-board the vehicle to capture at least minimum and maximum acceleration readings in each of an X-axis, a Y-axis and a Z-axis while the vehicle is in motion;
b. Calculating, based on the at least minimum and maximum acceleration readings captured, an axis independent acceleration value; and
c. Generating a set of axis independent acceleration values correlated with different observed speeds of the vehicle.

The method may include the further step of generating a set of fit coefficients for the set of axis independent acceleration values as compared to the observed speeds of the vehicle.

The method may further include the step of setting a threshold axis independent acceleration value, with an axis independent acceleration value above the threshold indicating that the vehicle is moving.

The method may further include the step of comparing the calculated axis independent acceleration value to the threshold axis independent acceleration value to determine whether the vehicle is moving and only estimating the speed of the vehicle when it has been determined that the vehicle is moving.

The method may further include the step of capturing an observed speed of the vehicle contemporaneously with the capture of the acceleration readings using an at least one accelerometer. The observed speed of the vehicle will preferably e captured contemporaneously using a different method or component such as GPS for example.

The method may include the further step of using the set of fit coefficients and/or the set of axis independent acceleration values correlated with an observed speed of the vehicle, to estimate the speed of any vehicle. Once the set of fit coefficients and/or the set of axis independent acceleration values correlated with an observed speed of the vehicle have been determined, the set of fit coefficients and/or the set of axis independent acceleration values correlated with an observed speed of the vehicle can be used to estimate the speed of any similar vehicle based only on the capture of the acceleration readings using an accelerometer while the vehicle is in motion, based solely on the vibration of the vehicle as measured by the acceleration sensor. This allows the mileage to be estimated even without data from a location device or a distance measuring device.

In an embodiment, at least a minimum and maximum acceleration readings in each of an X-axis, a Y-axis and a Z-axis may be captured and/or identified using an accelerometer. It is important to recognise that whilst an embodiment may be based on the use of at least minimum and maximum acceleration readings in each of an X-axis, a Y-axis and a Z-axis, any characteristic of the acceleration readings which varies over time, may be used.

To obtain the fit coefficients, the axis independent acceleration values are preferably aligned/correlated with the observed speed data. This is preferably done at the same collection frequency, for example 100 Hz axis independent acceleration values are aggregated to, and correlated with, 1 Hz speed data (although any capture frequency could be used for the acceleration data and/or the speed data).

The set of fit coefficients and/or the set of axis independent acceleration values correlated with an observed speed of the vehicle may be loaded onto an in-vehicle mobile telematics device.

The correlation of the axis independent acceleration values may be correlated with the observed speed data more than once over a single journey, or over more than one journey to increase accuracy. Alternatively, the correlation may take place at regular intervals as a back-up check.

The method may be divided into a calibration or model building stage where the acceleration measurements are used to calculate an axis independent acceleration value correlated with an observed speed of the vehicle. This may in turn be used to generate the set of fit coefficients.

The calibration or model building stage may be performed by any device which has access to both the acceleration readings captured and the associated speed and/or location data. The calibration or model building step may preferably be undertaken on a server or computing device associated with the in-vehicle mobile telematics device, rather than the in-vehicle mobile telematics device.

The method may then include an implementation stage where, once the set of fit coefficients and/or the set of axis independent acceleration values correlated with an observed speed of the vehicle have been established, these may be loaded onto an in-vehicle mobile telematics device which can then estimate mileage of the vehicle based solely on the acceleration data measure by the acceleration sensor and converted to one or more axis independent acceleration values. The one or more axis independent acceleration values can be mapped to a speed based on the set of fit coefficients and/or the set of axis independent acceleration values correlated with an observed speed of the vehicle to estimate mileage. The implementation or estimation stage of the method may be implemented on board an in-vehicle mobile telematics device and/or an associated device which could be mobile, such as a smartphone or tablet for example and/or a computer server or network. The implementation or estimation stage preferably requires only the acceleration readings and the set of fit coefficients and/or a set of axis independent acceleration values correlated with observed speed.

Preferably, once a set of fit coefficients and/or a set of axis independent acceleration values correlated with observed speed has been developed, either or both of these sets may be provided to an in-vehicle mobile telematics device, so that the estimated mileage can be calculated on board the in-vehicle mobile telematics device without the need for reliance on an associated location determining device or a device with the ability to determine its location and therefore observed vehicle speed.

The axis independent acceleration value(s) can be used by themselves (once correlated with the observed speed) or may be matched with other vehicle journey data which may provide a more accurate global picture of the journey and/or provide additional detail about any event which may occur during a journey.

The axis independent acceleration value(s) can be established using a mathematical formula. Preferably, the mathematical formula will remove the dependent on the particular axes in which the acceleration is measured.

One formula which can be used for calculation of the axis independent acceleration value(s) is:

$$sqrt ( ( x\_max - x\_min ) \hat{} 2 + ( y\_max - y\_min ) \hat{} 2 + ( z\_max - z\_min ) \hat{} 2 ) .$$

The acceleration data and/or the axis independent acceleration values may be divided into one or more bands or bins to allow for faster and/or more accurate processing. Any number of bands or bins may be used but the inventors have found that five bands or bins is an optimal number.

According to a second aspect there is provided an in-vehicle mobile telematics device implementing the method according to the broad aspect or the first aspect.

According to a third aspect there is provided a system comprising an in-vehicle mobile telematics device and a central server implementing the method according to the broad aspect or the first aspect and transmitting the set of fit coefficients and/or the set of axis independent acceleration values correlated with an observed speed of the vehicle to the in-vehicle mobile telematics device.

The step of setting a threshold axis independent acceleration value, with an axis independent acceleration value above the threshold indicating that the vehicle is moving will preferably occur at the in-vehicle mobile telematics device level.

The step of setting a threshold axis independent acceleration value may preferably occur once an axis independent acceleration value is known for different observed speeds. The selection of an axis independent acceleration value for an appropriately low speed will preferably be used as the threshold.

The system may further include a location determining device or a device with the ability to determine its location. An example may be a smartphone or tablet which includes software and/or hardware that allows access to a location or positioning system such as GPS. The observed speed of the vehicle may be captured by a sensor/device which is separate from the at least one accelerometer.

The at least one accelerometer will preferably be provided as a part of an in-vehicle mobile telematics device. The observed speed or changes in real-time location of a vehicle (which allows a calculation of vehicle speed) may be collected using a positioning/location system such as GPS. The positioning/location system may be provided in the vehicle, for example in an in-vehicle OEM telematics/navigation system or on a mobile device carried in the vehicle such as a smartphone or tablet for example.

The in-vehicle mobile telematics device will preferably be mounted within a vehicle. The in-vehicle mobile telematics device may be mounted in a specific location and/or orientation but this is not required due to the use of the axis independent acceleration values.

The in-vehicle mobile telematics device with at least one accelerometer will preferably be used with a location determining device, such as a smartphone. The in-vehicle mobile telematics device will preferably collect acceleration data and the location determining device will preferably collect location data. The in-vehicle mobile telematics device and the location determining device will preferably operate to collect the respective data independently of one another. The in-vehicle mobile telematics device and the location determining device will preferably operate to collect the respective data contemporaneously, preferably at the same frequency or at least respective frequencies that allow matching of the respective data sets.

The collected data can be used separately, but the use of the data together may be undertaken to provide increased accuracy and/or allows cross-checking of the data in one data set against the data in the other data set. In the absence of the location data set or as a backup or cross check for the location data, the acceleration data set comprising the axis independent acceleration values can be used together with the set of fit coefficients to estimate the mileage travelled. This may take place on the in-mobile telematics device, a mobile device such as a smartphone or tablet or on a server.

The observed speed of the vehicle or changes in real-time location of a vehicle (which allows a calculation of vehicle speed) may be captured and correlated with the acceleration data during a calibration or model building stage. Once the calibration or model building stage has been undertaken, the method of the invention can be used to estimate mileage based on the acceleration data alone, but the speed of the vehicle or changes in real-time location of a vehicle (which allows a calculation of vehicle speed) may be collected with the acceleration data for continued use together.

A calibration or model building stage may be undertaken for each in-vehicle mobile telematics device and/or a calibration or model building stage may be undertaken for each vehicle in which an in-vehicle mobile telematics device is provided and/or a calibration or model building stage may be undertaken for each type (make and/or model) of vehicle, which may allow a general set of fit coefficients and/or set of axis independent acceleration values to be used for each type of vehicle as a baseline. The amount of vibration will be different from vehicle to vehicle due to engine type, suspension type and age, road surface etc, the development of the set of axis independent acceleration values correlated with different observed speeds of the vehicle, will preferably occur at the in-vehicle mobile telematics device level. Once developed, the set of axis independent acceleration values correlated with different observed speeds of the vehicle can then be used directly to estimate mileage or used to develop the set of fit coefficients which is then used to estimate mileage.

The at least one accelerometer may preferably capture the accelerometer readings, which may then be processed to determine and store the characteristics of these readings over time. In one embodiment, maximum acceleration, minimum acceleration and mean acceleration values may be determined for any time step in the captured acceleration values. The acceleration values are preferably captured each second, and more preferably, multiple times every second at a capture frequency. Although any capture frequency could be used, a preferred capture frequency may be 100 Hz.

The acceleration values are preferably captured are preferably captured in multiple axes. Preferably, acceleration values are preferably captured are captured in an X-axis, a Y-axis and a Z-axis. The axes are preferably mutually orthogonal. The axes do not have to align with a direction, provided that multiple axis information is captured. This preferably allows the capture or multiple acceleration values from which an axis independent acceleration value can be calculated.

The axis independent acceleration value may be an average of a number of captured values, captured at the same time point. This creates an acceleration value which is independent of axial information.

One or more multi-axis accelerometers may be used to capture the acceleration data.

As mentioned above, the acceleration data is preferably captured at a given frequency, preferably 100 Hz. The steps which follow can be undertaken to determine an axis independent acceleration value for each measurement taken, that is 100 axis independent acceleration values per second. The efficacy of this approach will preferably be determined by processing power available. Whilst processing the captured data at the same frequency may increase accuracy of the estimate, it will also increase the processing power required.

The in-vehicle telematics device for example, may not have a sufficiently powerful processor. The processing of the captured data may therefore take place on a selected device. For example, if higher accuracy is required, such as in the steps of initially calculating, the axis independent acceleration value and/or generating a set of axis independent acceleration values correlated with different observed speeds of the vehicle, a more powerful processor may be used, such as on a server or smartphone or tablet, whereas once these steps have been undertaken, using the generated set of fit coefficients to estimate mileage based on the axis independent acceleration values measured may require less processing power and may be undertaken on the in-vehicle mobile telematics device.

The processing of the captured data may be undertaken at a lower frequency to the measurement. For example, if higher accuracy is required, such as in the steps of initially calculating, the axis independent acceleration value and/or generating a set of axis independent acceleration values correlated with different observed speeds of the vehicle, the processing may take place at the same frequency as the measurement, whereas once these steps have been undertaken, using the generated set of fit coefficients to estimate mileage based on the axis independent acceleration values measured may be undertaken at a lower frequency (based on aggregated data in a time period for example measurement at 100 Hz and processing in 1 Hz blocks).

In use, the method will preferably allow an in-vehicle telematics device and/or a related device such as a server, smartphone or tablet, to estimate the mileage travelled based on the vibrations detected by the at least one accelerometer without requiring a distance measuring or location determining device such as a GPS receiver. The estimated mileage can then be used for a variety of purposes, including, but not limited to, providing a check on the accuracy of a distance measuring or location determining device, to provide additional information in relation to a journey or event within a journey and/or as the mileage used when a distance measuring or location determining device is not available. The estimated mileage may be used to make changes to or optimise the operation of components of the in-vehicle telematics device to increase the accuracy of the in-vehicle telematics device or components thereof.

### DETAILED DESCRIPTION OF THE INVENTION

In order that the invention may be more clearly understood one or more embodiments thereof will now be described, by way of example only, with reference to the accompanying drawings, of which:

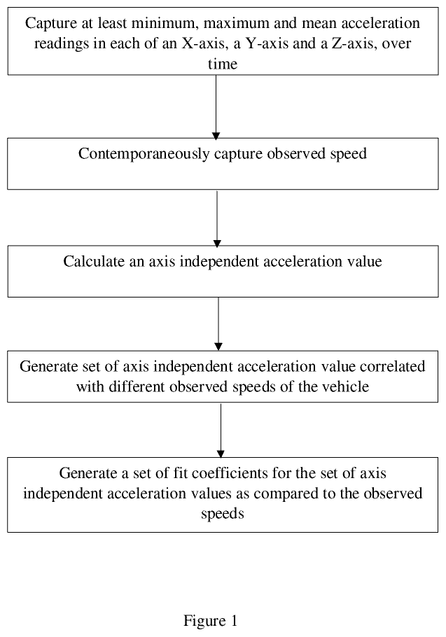

FIG. 1 is a flow chart of a calibration portion of a method of an embodiment.

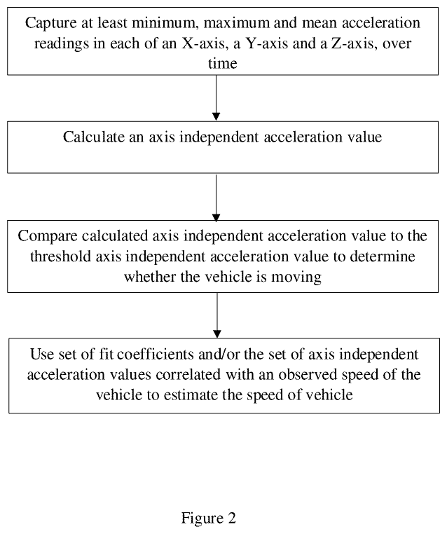

FIG. 2 is a flow chart showing implementation of a method of an embodiment without using a location or distance determining device.

In a preferred embodiment, a computer implemented method for generating a vehicle mileage is provided.

The method preferably comprises the steps of controlling at least one accelerometer on-board the vehicle to capture at least minimum. maximum and mean acceleration readings in each of an X-axis, a Y-axis and a Z-axis. In a preferred embodiment, this is accomplished using an acceleration sensor, preferably at least one accelerometer, while the vehicle is in motion. This will give a number of data values over time. Capturing these values gives nine values at each timestep, there values for acceleration in each axis.

The method then preferably involves the calculation of an axis independent acceleration value based on the at least minimum, maximum and mean acceleration readings captured.

Then the method comprises generating a set of axis independent acceleration values correlated with different observed speeds of the vehicle.

The method may be divided into a setup or calibration stage where the acceleration measurements are used to calculate an axis independent acceleration value correlated with an observed speed of the vehicle. This may in turn be used to generate the set of fit coefficients for the set of axis independent acceleration values as compared to the observed speeds of the vehicle.

In the calibration stage, the method may further include the step of capturing an observed speed of the vehicle contemporaneously with the capture of the minimum, maximum and mean acceleration readings in each of the X-axis, a Y-axis and a Z-axis and variations in these characteristics over time. This allows the correlation of the set of axis independent acceleration values with different observed speeds of the vehicle, but this step is not required in an implementation stage if a set of axis independent acceleration values correlated with different observed speeds of the vehicle, or a set of fit coefficients, is already available.

To obtain the fit coefficients, the axis independent acceleration values are preferably aligned/correlated with the observed speed data. This is preferably done at the same collection frequency, for example 100 Hz axis independent acceleration values are aggregated to, and correlated with, 1 Hz speed data (although any capture frequency could be used).

The method may include an implementation stage where, once a set of fit coefficients and/or a set of axis independent acceleration values correlated with an observed speed of the vehicle have been established, these may be loaded onto an in-vehicle mobile telematics device which can then estimate mileage of the vehicle based solely on the acceleration data measure by the acceleration sensor of the in-vehicle mobile telematics device (or of another associated device) when converted to one or more axis independent acceleration values. The one or more axis independent acceleration values measured during a vehicle journey can be mapped to a vehicle speed, based on the set of fit coefficients and/or the set of axis independent acceleration values correlated with an observed speed of the vehicle, to estimate mileage (through calculating speed of travel multiplied by the time at that speed).

Once the set of fit coefficients and/or the set of axis independent acceleration values correlated with an observed speed of the vehicle have been determined, the set of fit coefficients and/or the set of axis independent acceleration values correlated with an observed speed of the vehicle can be used to estimate the speed of any similar vehicle based only on the capture at least minimum and maximum acceleration readings in each of an X-axis, a Y-axis and a Z-axis using an acceleration sensor while the vehicle is in motion, based solely on the vibration of the vehicle as measured by the acceleration sensor. This allows the mileage to be estimated even without data from a location device or a distance measuring device.

The set of fit coefficients and/or the set of axis independent acceleration values correlated with an observed speed of the vehicle may be loaded onto an in-vehicle mobile telematics device.

The method may be implemented on board an in-vehicle mobile telematics device and/or an associated device, which could be mobile (that is in the vehicle with the acceleration sensor), such as a smartphone or tablet for example and/or fixed such as a computer server or network.

The method may further include the step of setting a threshold axis independent acceleration value, with an axis independent acceleration value above the threshold indicating that the vehicle is moving. This may involve comparing the calculated axis independent acceleration value to the threshold axis independent acceleration value to determine whether the vehicle is moving and only estimating the speed of the vehicle when it has been determined that the vehicle is moving.

The axis independent acceleration values may be correlated with the observed speed data more than once over a single journey, or over more than one journey to increase accuracy. In other words, a calibration stage may be undertaken in any journey. A calibration stage may be undertaken while a journey is underway.

A calibration stage may take place at regular intervals as a back-up check. For example, one journey out of every ten journeys may be designated as a calibration journey.

In an embodiment, once a set of fit coefficients and/or a set of axis independent acceleration values correlated with observed speed has been developed, either or both of these sets may be provided to an in-vehicle mobile telematics device, so that the estimated mileage can be calculated on board the in-vehicle mobile telematics device without the need for reliance on an associated location determining device or a device with the ability to determine its location and therefore observed vehicle speed.

The axis independent acceleration value(s) can be used by themselves (once correlated with the observed speed) or may be matched with other vehicle journey data which may provide a more accurate global picture of the journey and/or provide additional detail about any event which may occur during a journey.

The axis independent acceleration value(s) is preferably established using a mathematical formula. Preferably, the mathematical formula will remove the dependent on the particular axes in which the acceleration is measured. One formula which can be used is:

$$sqrt ( ( x\_max - x\_min ) \hat{} 2 + ( y\_max - y\_min ) \hat{} 2 + ( z\_max - z\_min ) \hat{} 2 )$$

The acceleration data and/or the axis independent acceleration values may be divided into one or more bands or bins to allow for faster and/or more accurate processing. Any number of bands or bins may be used but the inventors have found that five bands or bins is an optimal number.

The method may be implemented in a system comprising an in-vehicle mobile telematics device and a central server. The in-vehicle mobile telematics device may capture the acceleration data and transfer the captured data to the central server for processing. In particular, the central server may undertake the processing of the captured data for a calibration stage which may involve more data and thus require greater processing power. The central server may implement the method to arrive a set of fit coefficients and/or the set of axis independent acceleration values correlated with an observed speed of the vehicle, and then transmit the set of fit coefficients and/or the set of axis independent acceleration values correlated with an observed speed of the vehicle, to the in-vehicle mobile telematics device. The in-vehicle mobile telematics device may then be able to estimate the speed of the vehicle and thus estimate the mileage of one or more journeys.

A threshold axis independent acceleration value, with an axis independent acceleration value above the threshold indicating that the vehicle is moving may calculated by a server and be provided to the in-vehicle mobile telematics device. The threshold will preferably be set for each in-vehicle mobile telematics device (each vehicle). This is likely to be far more accurate given the differences in vibrations (and the related acceleration data) which are likely to occur from vehicle to vehicle.

Setting a threshold axis independent acceleration value may preferably occur once an axis independent acceleration value is known for different observed speeds. The selection of an axis independent acceleration value for an appropriately low speed will preferably be used as the threshold. For example, a threshold axis independent acceleration value may be selected for 2-5 kilometres per hour, with an axis independent acceleration value above the threshold being determined as the vehicle moving.

The system of a preferred embodiment includes a location determining device or a device with the ability to determine its location associated with the in-vehicle mobile telematics device. A location determining device or a device with the ability to determine its location may be integrated into the in-vehicle mobile telematics device, or a separate but associated device, for example a smartphone or tablet which includes software and/or hardware that allows access to a location or positioning system such as GPS could be used. Use of a positioning system such as GPS means that the observed speed of the vehicle may be captured by a sensor/device which is separate from the at least one accelerometer. Capturing the observed speed of the vehicle contemporaneously with the vibration information in the form of the acceleration data, particularly during the calibration stage allows the set of fit coefficients and/or a set of axis independent acceleration values correlated with observed speed to be developed.

The at least one accelerometer used to capture the acceleration data will preferably be provided as a part of an in-vehicle mobile telematics device.

In an embodiment, the observed speed or changes in real-time location of a vehicle (which allows a calculation of vehicle speed) may be collected using a positioning/location system such as GPS. The positioning/location system may be provided in the vehicle, for example in an in-vehicle OEM telematics/navigation system or on a mobile device carried in the vehicle such as a smartphone or tablet for example.

The in-vehicle mobile telematics device will preferably be mounted within a vehicle. The in-vehicle mobile telematics device may be mounted in a specific location and/or orientation, but this is not required due to the use of the axis independent acceleration values.

The in-vehicle mobile telematics device with at least one accelerometer will preferably be used with a location determining device, such as a smartphone. The in-vehicle mobile telematics device will preferably collect acceleration data and the location determining device will preferably collect location data. The in-vehicle mobile telematics device and the location determining device will preferably operate to collect the respective data independently of one another but contemporaneously, preferably at the same frequency or at least respective frequencies that allow matching of the respective data sets.

The collected data can be used separately, but the use of the data together may be undertaken to provide increased accuracy and/or allows cross-checking of the data in one data set against the data in the other data set. In the absence of the location data set or as a backup or cross check for the location data, the acceleration data set comprising the axis independent acceleration values can be used together with the set of fit coefficients to estimate the mileage travelled. This may take place on the in-mobile telematics device, a mobile device such as a smartphone or tablet or on a server.

The observed speed of the vehicle or changes in real-time location of a vehicle (which allows a calculation of vehicle speed) are preferably captured and correlated with the acceleration data during the calibration stage. Once the calibration stage has been undertaken, preferably for each in-vehicle mobile telematics device and vehicle pair, the method of the invention can be used to estimate mileage based on the acceleration data alone, but the speed of the vehicle or changes in real-time location of a vehicle (which allows a calculation of vehicle speed) may be collected with the acceleration data for continued use together, for example for validation.

Although the calibration or model building stage may be undertaken for each in-vehicle mobile telematics device and vehicle pair (and therefore be specific to that pair), a calibration or model building stage may be undertaken for each vehicle in which an in-vehicle mobile telematics device is provided and/or a calibration or model building stage may be undertaken for each type (make and/or model) of vehicle, which may allow a general set of fit coefficients and/or set of axis independent acceleration values to be used for each type of vehicle as a baseline.

The amount of vibration will be different from vehicle to vehicle due to engine type, suspension type and age, road surface etc, and therefore the development of the set of axis independent acceleration values correlated with different observed speeds of the vehicle, will preferably be based on the in-vehicle mobile telematics device and vehicle pair for maximum accuracy. Once developed, the set of axis independent acceleration values correlated with different observed speeds of the vehicle can then be used directly to estimate mileage or used to develop the set of fit coefficients which is then used to estimate mileage.

The at least one accelerometer may preferably record the maximum acceleration, minimum acceleration and mean acceleration value. The acceleration values are preferably captured each second, and more preferably, multiple times every second at a capture frequency. The capture frequency may be 100 Hz.

The acceleration values are preferably captured are preferably captured in multiple axes. Preferably, acceleration values are preferably captured are captured in an X-axis, a Y-axis and a Z-axis. The axes are preferably mutually orthogonal. The axes do not have to align with a direction, provided that multiple axis information is captured. This preferably allows the capture or multiple acceleration values from which an axis independent acceleration value can be calculated.

One or more multi-axis accelerometers may be used to capture the acceleration data.

As mentioned above, the acceleration data is preferably captured at a given frequency, preferably 100 Hz. The steps which follow can be undertaken to determine an axis independent acceleration value for each measurement taken, that is 100 axis independent acceleration values per second. The efficacy of this approach will preferably be determined by processing power available. Whilst processing the captured data at the same frequency may increase accuracy of the estimate, it will also increase the processing power required.

The in-vehicle telematics device for example, may not have a sufficiently powerful processor. The processing of the captured data may therefore take place on a selected device. For example, if higher accuracy is required, such as in the steps of initially calculating, the axis independent acceleration value and/or generating a set of axis independent acceleration values correlated with different observed speeds of the vehicle, a more powerful processor may be used, such as on a server or smartphone or tablet, whereas once these steps have been undertaken, using the generated set of fit coefficients to estimate mileage based on the axis independent acceleration values measured may require less processing power and may be undertaken on the in-vehicle mobile telematics device.

The processing of the captured data may be undertaken at a lower frequency to the measurement. For example, if higher accuracy is required, such as in the steps of initially calculating, the axis independent acceleration value and/or generating a set of axis independent acceleration values correlated with different observed speeds of the vehicle, the processing may take place at the same frequency as the measurement, whereas once these steps have been undertaken, using the generated set of fit coefficients to estimate mileage based on the axis independent acceleration values measured may be undertaken at a lower frequency (based on aggregated data in a time period for example measurement at 100 Hz and processing in 1 Hz blocks).

It is important to recognise that whilst the current preferred embodiment is based on the use of at least minimum and maximum acceleration readings in each of an X-axis, a Y-axis and a Z-axis, any characteristic of the acceleration readings which varies over time, may be used.

The one or more embodiments are described above by way of example only. Many variations are possible without departing from the scope of protection afforded by the appended claims.

1. A computer implemented method for generating a vehicle mileage comprising:
controlling at least one accelerometer on-board the vehicle to capture acceleration readings in one or more axes while the vehicle is in motion;
calculating, based on the acceleration readings captured, an axis independent acceleration value; and
generating a set of axis independent acceleration values correlated with different observed speeds of the vehicle.

2. The computer implemented method as claimed in claim 1 wherein one or more statistical characteristics of the acceleration readings is used in calculating the axis independent acceleration value.

3. The computer implemented method as claimed in claim 1 wherein at least minimum and maximum acceleration readings are used in calculating the axis independent acceleration value.

4. The computer implemented method as claimed in claim 1 further including the step of setting a threshold axis independent acceleration value, with an axis independent acceleration value above the threshold indicating that the vehicle is moving.

5. The computer implemented method as claimed in claim 1 further including comparing the calculated axis independent acceleration value to the threshold axis independent acceleration value to determine whether the vehicle is moving and only estimating the speed of the vehicle when it has been determined that the vehicle is moving.

6. The computer implemented method as claimed in claim 1 further including generating a set of fit coefficients for the set of axis independent acceleration values as compared to the observed speeds of the vehicle.

7. The computer implemented method as claimed in claim 1 further including using the set of fit coefficients and/or the set of axis independent acceleration values correlated with an observed speed of the vehicle, to estimate the speed of any vehicle.

8. The computer implemented method as claimed in claim 7 further including estimating the mileage travelled based on the speed estimated and the time travelled at the speed estimated.

9. The computer implemented method as claimed in claim 6 wherein to obtain the fit coefficients, the axis independent acceleration values are correlated with the observed speed data.

10. The computer implemented method as claimed in claim 1 further including capturing observed speed data using a positioning/location system.

11. The computer implemented method as claimed in claim 10 wherein the capturing of an observed speed of the vehicle occurs contemporaneously with the capture of the acceleration readings.

12. (canceled)

13. (canceled)

14. The computer implemented method as claimed in claim 1 wherein the acceleration data and/or the axis independent acceleration values are divided into one or more bands or bins for processing optimisation.

15. The computer implemented method as claimed in claim 1 wherein the at least one acceleration sensor captures the maximum acceleration, minimum acceleration and a mean acceleration value on each axis.

16. The computer implemented method as claimed in claim 1 implemented on board an in-vehicle mobile telematics device and/or an associated computing device.

17. An in-vehicle mobile telematics device implementing the method according to claim 1.

18. A system comprising an in-vehicle mobile telematics device and a central server implementing the method according to claim 1 and transmitting the set of axis independent acceleration values correlated with an observed speed of the vehicle or a set of fit coefficients based thereon, to the in-vehicle mobile telematics device.

19. The system as claimed in claim 18 further including a location determining device to capture the observed speed of the vehicle.

20. The system as claimed in claim 19 wherein the location determining device is provided in a mobile computing device separate from the in-vehicle mobile telematics device comprising the at least one accelerometer.

21. The system as claimed in claim 20 wherein the location determining device and the mobile computing device are carried in the same vehicle and wherein the in-vehicle mobile telematics device captures acceleration data and the location determining device captures location data independently of one another but contemporaneously to allow matching of the acceleration data and the location data.

22. (canceled)

23. The system as claimed in claim 21 wherein the observed speed of the vehicle is captured via the location data and correlated with the acceleration data during a calibration/model building stage and once the calibration/model building stage has been undertaken, the set of axis independent acceleration values correlated with an observed speed of the vehicle, or a set of fit coefficients based thereon is used to estimate mileage.

24. (canceled)

25. (canceled)
